(19) United States
(12) Patent Application Publication
(10) Pub. No.: US 2004/0135280 A1
(43) Pub. Date: Jul. 15, 2004

(54) Apparatus and process for production of isocyanate based fiber reinforced composite materials

(76) Inventors: Stephen J. O'Nien, Billingham (GB); Geoffrey M. Michalak, Roseville, MI (US)

Correspondence Address: Patent Counsel, Huntsman Polyurethanes, 286 Mantua Grove Road, West Deptford, NJ, 08066-1732, US

(21) Appl. No.: 10/465,063

(22) Filed: Jun. 19, 2003

Related U.S. Application Data
(60) Provisional application No. 60/391,716, filed on Jun. 26, 2002.

(51) Int. Cl. B29C 31/00

(52) U.S. Cl. 264/54; 264/240; 264/349; 425/200; 425/4 C

(57) ABSTRACT

An improved apparatus and process for the production of isocyanate derived fiber reinforced materials by reactive processing. The improved apparatus comprises a mixing apparatus containing a mixing chamber, means for the metered introduction of at least two liquid reactive chemical streams into the chamber, means for introduction of reinforcing fibers into the chamber, an outlet duct for conducting a liquid reaction mixture comprising reinforcing fibers from the mixing chamber, and at least five gas jets suitably arranged to promote the fluidization and improved mixing of the liquid reaction mixture with the reinforcing fibers as the liquid reaction mixture comprising reinforcing fibers emerges from the outlet tube. Also disclosed is an improved process for producing fiber reinforced composites by employing the apparatus, and composites prepared according to the improved process.

### CROSS-REFERENCE TO RELATED APPLICATIONS

This application claims priority to U.S. Provisional Application Serial No. 60/391,716, filed Jun. 26, 2002.

### FIELD OF THE INVENTION

The present invention pertains to an apparatus and process for the production of fiber reinforced reactively processed composite materials based on polyisocyanates.

### BACKGROUND OF THE INVENTION

It is known to produce fiber reinforced composites by simultaneously injecting reinforcing fibers at a point where liquid reactive chemical streams are mixed. Mixing devices have been developed to allow for the simultaneous mixing of two or more liquid reactive chemical streams, which ultimately form the matrix polymer, with the reinforcing fibers in a mixing chamber. The liquid reactive chemical streams are co-injected over the reinforcing fibers within the mixing chamber, usually under conditions such that the liquid streams impinge under high pressure. If desired, the reinforcing fibers can be cut into fiber segments of defined length from one or more continuous fiber bundles prior to entering the mixing chamber. The resulting reaction mixture, consisting of the polymer-forming liquid reactive chemicals and reinforcing fibers, is then expelled from the mixing chamber via an outlet, from which point it enters a shape-defining element, such as a mold. This process is sometimes referred to in the art as “long fiber injection” (or “LFI”). It combines the advantages of using relatively long reinforcing fibers (i.e. strength and impact resistance) with improved fiber wetting and penetration. It also eliminates the extra step of pre-placing a long fiber reinforcing structure into a shape-defining element prior to the introduction of the polymer forming reactive chemical mixture.

Prior art documents describing LFI processes, and mixing devices designed for such processes include, for example, EP 895,815; U.S. Pat. No. 5,858,416; and U.S. Pat. No. 6,079,867. It is known to augment the distribution of the spray output from an LFI mixing apparatus by employing one or more jets of gas adjacent to the outlet of the mixing apparatus. EP 895,815 discloses a system of two gas jets designed to produce a deflection of the fiber-containing reaction mixture as it emerges from the outlet of the LFI type mixing apparatus. It further provides a detailed design of such a mixing apparatus. Other LFI mixing devices are known to use up to four gas jets around the outlet of the mixing device. The apparatus disclosed in EP 895,815, and similar devices known to be in use, are equipped with complex electronic circuitry and control systems designed to optimize and modulate the timing of the resin stream deflection during any single reaction mixture discharge from the mixing device. The individual gas jets are independently controlled, with respect to each other, for this purpose.

The preferred mode of operation of the device disclosed in EP 895,815 uses the individual gas jets intermittently during the course of each discharge (shot), and in alternation. This pattern of intermittent and alternating gas bursts during the shot has the effect of alternately deflecting the emerging stream in different directions during the shot. The alternating deflections of the emerging stream from the mixing apparatus occur at high frequency (i.e. at least several times per second) during the course of each individual resin shot. It is stated in EP 895,815 that this pattern of alternating deflections improves resin coverage on the substrate during each shot. However, the relative timing and duration of gas bursts from each gas jet must be very precisely controlled in order to achieve the desired pattern of stream deflections.

Prior art LFI mixing devices have a limited ability to break up clumps of the reinforcing fiber material. The reinforcing fiber material, typically glass fiber, is fed into the mixing apparatus in bundles. The bundles are then chopped at appropriate times during the course of the resin shot in order to control the length of the fibers that emerge from the mixing apparatus. The chopped fibers may remain at least partially bundled even after emerging from the mixing device with the liquid resin mixture. This can interfere with both fiber wetting and with the distribution of the fibers in the final composite article. When the fibers are not fully wetted by the resin or are not evenly distributed in the resin, the final composite part may have sub-optimal mechanical properties and/or visible surface defects. The prior art LFI mixing devices do not adequately deal with the problem of breaking up bundled reinforcing fibers and distributing them evenly throughout the liquid resin mixture. This problem is most severe at high fiber loadings.

There is a need in the art for an LFI mixing device which can 1) handle mixing activated resin systems comprising at least two mutually reactive liquid polymer precursor streams, such as polyisocyanates and polyol compositions, 2) provide for adequate metering of the individual resin steams, and 3) provide for adequate dispersal of the reinforcing fiber bundles in the resin mixture. There is also a need for an LFI mixing device which can achieve adequate resin dispersal of the fibers even at high fiber loadings (i.e. fiber loadings of greater than 30% by weight of the final fiber reinforced composite, and preferably fiber loadings of greater than 50% by weight of the final fiber reinforced composite).

### SUMMARY OF THE INVENTION

The present invention provides an improved mixing apparatus suitable for use in a long fiber injection (LFI) process that produces fiber reinforced composite articles. The mixing apparatus includes a mixing chamber having means for simultaneously metering at least two mutually reactive liquid polymer precursor streams into the mixing chamber. In addition, the apparatus of the present invention contains separate means for introducing a mass of reinforcing fibers into the mixing chamber. The reinforcing fibers, generally having an average length of at least 0.25 inches, are mixed with the reactive liquid polymer precursor streams in the mixing chamber to form a fiber-reacting mixture. The fiber-reacting mixture is then discharged from the mixing chamber through outlet means extending from the mixing chamber onto a substrate. The outlet means contains at least five gas jets arranged in a ring or circumferentially around the opening where the fiber-reacting mixture is discharged from the mixing chamber, the gas jets being capable of simultaneously directing a continuous flow of gas onto the fiber-reacting mixture as it emerges through the discharge opening.

In another feature of the present invention, at least eight gas jets are arranged in a ring or circumferentially with respect to the outlet means. In another feature of the present invention the gas jets are arranged at equally spaced intervals in a circular ring about the outlet means, wherein the plane defined by the circular ring is arranged perpendicularly to the direction of flow of the fiber-reacting mixture. The circular ring and gas jets are arranged such that the flow of the fiber-reacting mixture passes through the center of the circular ring.

In yet another feature of the present invention at least one of the mutually reactive liquid polymer precursor streams comprises an organic polyisocyanate, and another of the mutually reactive liquid polymer precursor streams comprises an isocyanate component which is capable of reacting with the polyisocyanate to form a polymer.

Another feature of the present invention provides a process for producing a fiber reinforced composite article, the process using the improved mixing apparatus described above.

The present invention also provides fiber reinforced composite articles of improved quality, the articles being prepared according to the process of the present invention.

### BRIEF DESCRIPTION OF THE DRAWINGS

FIG. 1 is a schematic view of a mixing apparatus according to the present invention, showing the outlet for the reaction mixture and a series of five gas jets arranged circumferentially with respect to the outlet, the jets being connected to a common source of pressurized gas, and a single valve for controlling the flow of the gas to all of the jets;

FIG. 2 is a schematic view of a mixing apparatus according to the present invention, showing the outlet for the reaction mixture and a series of eight gas jets arranged circumferentially with respect to the outlet, the jets being connected to a common source of pressurized gas, and a single valve for controlling the flow of the gas to all of the jets; and

FIG. 3 is a schematic view of a single gas jet having a gas flow direction at an angle of 45 degrees relative to the circular ring defined by the ring of gas jets.

### DETAILED DESCRIPTION OF THE INVENTION

The invention provides an improved mixing apparatus suitable for use in a long fiber injection process using a multi-component mixing activated reaction system, the reaction system comprising a plurality of liquid polymer precursor streams that combine to form a polymer matrix.

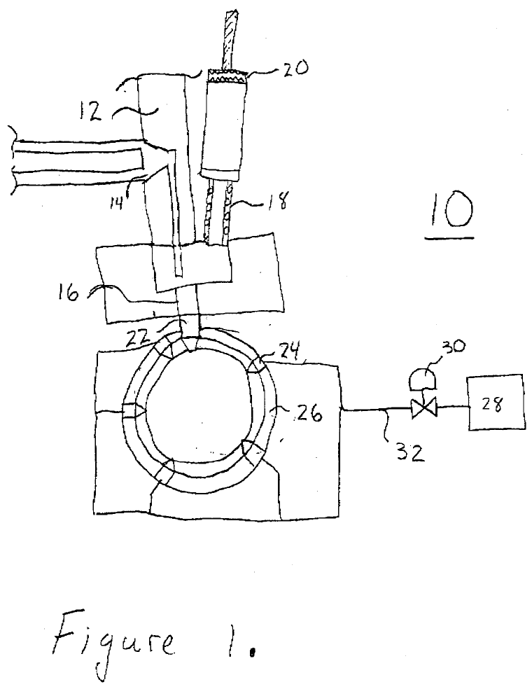

Referring now to FIG. 1, the improved mixing apparatus 10 includes a mixing chamber 12 having at least one inlet 14 in addition to means for the simultaneous metering and mixing of at least two liquid mutually reactive polymer precursor streams. The polymer precursor streams, initially contained in holding means such as a tank, are delivered to the mixing chamber by metering means such as a pump, where the streams are combined in mixing means such as a mixing head 16.

Additionally, the mixing apparatus contains feeding means 18 for feeding a mass of reinforcing fibers by conveyor, rollers, or other suitable means into the mixing chamber. Prior to entering the mixing chamber, the fibers are cut to a pre-determined length by cutting means 20 so as to have an average fiber length of at least 0.25 inches, preferably an average length greater than 0.25 inches, more preferably an average length greater than 0.3 inches, and still more preferably an average length of at least 0.5 inches. Inside the mixing head 16, the polymer precursor streams and reinforcing fibers react to form a fiber-reacting mixture.

The mixing apparatus also includes an outlet means 22 such as a discharge duct for conducting the fiber-reacting mixture, comprising polymer precursors and reinforcing fibers, from the mixing head onto a substrate. The mixing chamber and mixing head suitable for use in the present invention can be designed to accommodate exactly two polymer precursor streams and one reinforcing fiber stream so as to have two polymer precursor inlet ducts, a single reinforcing fiber inlet duct for introducing fibers of a controlled length, and a single outlet duct for dispensing the fiber-reacting mixture from the mixing chamber.

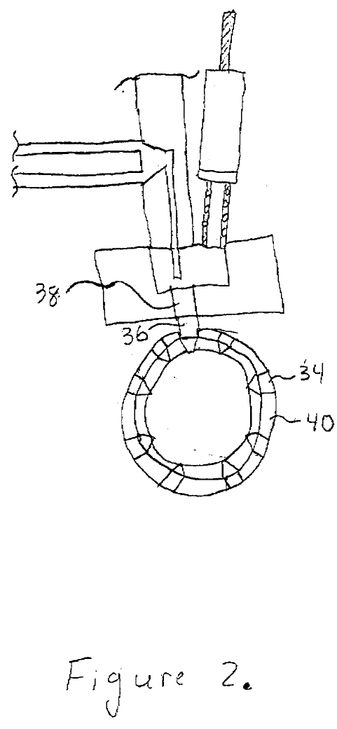

The mixing apparatus 10 of the present invention also includes a series of at least five gas jets 24 arranged circumferentially or peripherally on a ring 26 connected to the outlet 22 of mixing head 16. Although the ring 26 is depicted in FIGS. 1 and 2 as circular, it can include other shapes and forms having a generally round shape including an oval, ellipse or similar annular shape. The arrangement of the gas jets 24 is such that the jets are capable of impinging a stream of gas onto the fiber-reacting mixture as the latter emerges from the outlet 22 of the mixing head. Preferably, all of the gas jets 24 impinging a stream of gas upon the fiber-reacting mixture are symmetrically arranged with respect to the fiber-reacting mixture as it emerges from the outlet 22 of the mixing chamber. It is further preferred that all of the jets operate continuously and provide an equal and steady stream of gas during the dispensation of the fiber-reacting mixture as it flows from the outlet 22 of the mixing chamber.

In one embodiment, all gas jets 24 are similar in size and shape, and all connect to the same source of gas 28, with the source of gas being delivered to the gas jets via a single gas valve 30 and gas line 32. Preferably, all gas jets 24 of the present invention are operated together whereby the amount of gas delivered to each jet is equal. However, it would be within the scope of the invention to operate the jets independently from each other by using different gas valves, connected to at least one gas source, to deliver gas to at least one jet. The pressurized gas generally used in the present invention is an inert gas. Non-limiting examples of inert gases that may be used in this system include air and more preferably dry air; nitrogen; argon; helium; carbon dioxide; and any mixture of these gases. The most preferred gas for use in the apparatus of the invention is dry air.

Referring now to FIG. 2, in another embodiment of the present invention, there are minimally eight gas jets 34 arranged symmetrically with respect to the outlet 36 of the mixing head 38 so as to be in a circular plane adjacent to the outlet 36 of the mixing head 38 and with the outlet 36 of the mixing head 38 at the center of the circular plane. In this embodiment, the eight gas jets 34 are evenly spaced around a ring 40 such that all of the jets will impinge upon the fiber-reacting mixture as it emerges from the outlet 36 of the mixing head 38. However, it would be within the scope of the invention to space the jets unevenly around the ring 40 when delivering gas to the emerging mixture.

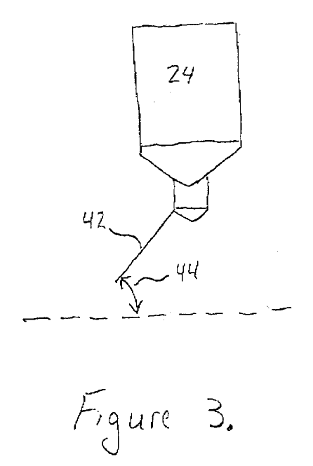

Referring now to FIG. 3, it is highly preferable that the direction of the gas flow 42 from all the gas jets 24 is directed onto the emerging stream of the fiber-reacting mixture and that the direction or line of gas flow 42 from all gas jets 24 is set at the same angle relative to the circular plane. The preferred angle 44 is 45 degrees, relative to the circular plane defined by the ring of gas jets, as shown in FIG. 3. In this embodiment the continuous and simultaneous operation of all the gas jets is more desirable than the intermittent and alternating operation of the jets as disclosed in the prior art. An object of the present invention is not to produce a deflection of the fiber-reacting mixture as it emerges from the outlet of the mixing chamber. Although it is preferred that no such deflection is produced by the arrangement of gas jets according to this invention, it is within the scope of the invention to do so.

It has been unexpectedly and surprisingly found that the use of at least five gas jets, more preferably at least eight gas jets, the jets being arranged in a ring or circumferentially with respect to the outlet of the mixing chamber, provides for a better dispersion of the reinforcing fibers contained within the fiber-reacting mixture. This advantage is available even when the complex electronic control apparatus, used in the prior art for intermittent and alternating operation of separate (independently controlled) gas jets, is omitted. Accordingly, the present invention has achieved a simplification of the overall design of the mixing apparatus as well as an improvement in fiber dispersal performance in relation to prior art systems using a smaller number of gas jets. The simplified design of the present invention nevertheless provides for adequate dispensing of the fiber-reacting mixture onto a substrate.

A particularly relevant example of a prior art LFI mixing apparatus, and the method of its operation in preparing composite articles, is provided in EP 895,815, the subject matter of which is incorporated herein fully by reference. The design of this mixing chamber, comprising inlets for the two liquid polymer precursor streams, a separate inlet suitable for the introduction of reinforcing fibers, an outlet for the fiber-reacting mixture, and other features not directly related to the system of gas jets described in the present invention, provides an example of a mixing apparatus suitable for use as the “mixing chamber” component in the context of the present invention (as defined hereinabove). When this mixing apparatus is combined with the improved system of gas jets described hereinabove, the resulting novel apparatus provides a preferred example of the improved LFI mixing apparatus according to the present invention. This example however is not to be construed as limiting.

It would be within the scope of the invention to use the improved system of gas jets in combination with one or more of the prior art systems of gas jets, wherein the latter is specifically designed to promote lateral displacements of the flow of the fiber-reacting mixture from the outlet of the mixing chamber. It is to be emphasized that the system of gas jets in the present invention is not itself, designed or intended to promote displacement of the flow of the fiber reacting mixture. Its primary benefit is improved dispersion of the reinforcing or glass fibers in the fiber-reacting mixture. To the extent that the prior art system is helpful in improving the distribution of the fiber-reacting mixture on the substrate, and provided that it does not interfere with the operation of the improved system according to the invention, the prior art system may be employed as an additional, but optional, feature of the mixing apparatus according to the present invention.

The present invention further provides an improved LFI process for producing fiber reinforced composites. The improved LFI process employs the improved mixing apparatus according to the present invention (as described hereinabove) for combining at least two liquid mutually reactive polymer precursor streams and a mass of reinforcing fibers, the fibers having an average length of at least 0.25 (preferably greater than 0.3) inches, to thereby form a fiber-reacting mixture. The fiber-reacting mixture is then dispensed from an outlet of the improved mixing apparatus onto a substrate. The preferred substrate is a mold. The improved process provides for improved distribution of the reinforcing fibers within both the fiber-reacting mixture and the composite articles formed therefrom.

In operating the process according to the present invention the polymer precursor streams are metered into the improved mixing apparatus at a controlled weight ratio. As is known in the art, control of the weight ratio of the polymer precursor streams is important in controlling the reaction stoichiometry.

The reaction stoichiometry is expressed in the polyurethanes art by a quantity known as the “Index”. The Index of a reactively processed isocyanate-based mixing activated formulation is simply the ratio of the number of isocyanate equivalents (indicating the number of —NCO groups available) to the number of equivalents of isocyanate reactive groups (indicating the number of available groups which are capable of reacting with the isocyanate under the conditions used in the reaction). This equivalents ratio is usually expressed as a percent. An Index of greater than 100 (i.e. 100%) indicates an excess of isocyanate groups relative to isocyanate reactive groups, and vice versa. A recommended range of Index values used in one embodiment of the process of the present invention is from about 80 to about 150, but may extend as high as about 1500 if a catalyst for the trimerization of isocyanate groups is present in the formulation. A more preferred range of Index values is between 90 and 130, still more preferably between 95 and 120, even more preferably between 98 and 110 and most preferably between 100 and 105. It is believed that most of the excess isocyanate is consumed by traces of reactive species or moisture on the surface of the reinforcing fibers.

The reinforcing fibers are also metered into the mixing chamber or mixing head and chopped at appropriate times during the shot, so as to control the average fiber length in the resulting fiber-reacting mixture. Methods for introducing reinforcing fibers into the mixing apparatus are also well known in the art and can include a conveyor or feed rollers.

In another embodiment of the present invention the mixing activated isocyanate based polymer precursor streams are combined with the reinforcing fibers in the improved LFI mixing apparatus, and the resulting fiber-reacting mixture is dispensed into an open mold, which also is capable of being closed. The mold is closed while the reaction system is still in a flowable state in order to produce a fully shaped article. In a particularly preferred embodiment this article is foamed, and at least some of the expansion of the foam takes place after the mold is closed to provide for effective filling of the mold.

The improved process according to the invention may also be used in combination with one or more fibrous mat reinforcing structures wherein the mat reinforcing structures are pre-placed within a mold cavity before the fiber-reacting mixture is introduced into the mold. These optional mat reinforcing structures are porous and can be penetrated by the fiber-reacting mixture. When used, this mat reinforcing structure provides an additional reinforcement to the composite article that is subsequently produced.

In another embodiment of the present invention, the LFI process provides just two liquid mutually reactive polymer precursor streams. In yet another embodiment of this two-polymer precursor stream process, one of these polymer precursor streams is an organic di- or polyfunctional isocyanate (hereinafter “polyisocyanate”) and the opposing liquid polymer precursor stream is a polyfunctional isocyanate reactive component (hereinafter “isocyanate component”).

### Polyisocyanate Precursor Stream

The polyisocyanate preferably consists of organic polyisocyanates having a number averaged isocyanate (—NCO) functionality of at least 1.8 to about 4.0. In practicing a more preferred embodiment of the LFI process according to the invention, the number averaged isocyanate functionality of the polyisocyanate composition is about 2.0 to about 3.0, more preferably from about 2.3 to about 2.9. It is to be understood, unless otherwise stated, that all functionalities, molecular weights, and equivalent weights described herein with respect to polymeric materials are number averaged; and, that all functionalities, molecular weights, and equivalent weights described with respect to pure compounds are absolute.

The organic polyisocyanates useful in embodiments of the present invention include any of the aliphatic, cycloaliphatic, araliphatic, or aromatic polyisocyanates known to those skilled in the art. Especially preferred are those polyisocyanates that are liquid at 25° C. Examples of suitable polyisocyanates include 1,6-hexamethylenediisocyanate; isophorone diisocyanate; 1,4-cyclohexane diisocyanate; 4,4′-dicyclohexylmethane diisocyanate; 1,4-xylylene diisocyanate; 1,4-phenylene diisocyanate; 2,4-toluene diisocyanate; 2,6-toluene diisocyanate; 4,4′-diphenylmethane diisocyanate (4,4′-MDI); 2,4′-diphenylmethane diisocyanate (2,4′-MDI); polymethylene polyphenylene polyisocyanates (crude, or polymeric, MDI); and 1,5-naphthalene diisocyanate. Mixtures of these polyisocyanates can also be used. Moreover, polyisocyanate variants, for example polyisocyanates that have been modified by the introduction of urethane, allophanate, urea, biuret, carbodiimide, uretonimine, isocyanurate, and/or oxazolidone residues can also be used.

In another embodiment of the present invention, isocyanate terminated prepolymers may be employed as the polyisocyanate precursor stream. Such prepolymers are generally prepared by reacting a molar excess of polymeric or pure polyisocyanate with one or more polyols. The polyols may include aminated polyols, imine or enamine modified polyols, polyether polyols, polyester polyols or polyamines. Pseudoprepolymers, which are a mixture of at least one isocyanate terminated prepolymer and one or more monomeric di- or polyisocyanates, may also be used.

Examples of commercially available polyisocyanate useful in the process of the present invention include the RUBINATE® series of polymeric isocyanates available from Huntsman Polyurethanes. In one embodiment, the polyisocyanate of the present invention is RUBINATE® 8700 isocyanate. This liquid isocyanate is of the polymeric MDI type and has an —NCO content of 31.5% by weight and a number averaged isocyanate group functionality of 2.7.

### Isocyanate Component Precursor Stream

The two-polymer precursor stream process of the present invention also employs an isocyanate component as the second liquid polymer precursor stream. In one embodiment of the invention the isocyanate component comprises organic polyols of the type well known in the polyurethanes art including softblock polyols, rigid polyols, and chain extenders or crosslinkers. The isocyanate component can further comprise a chemical blowing (foaming) agent, such as water, that reacts with the polyisocyanate in the opposing polymer precursor stream forming carbon dioxide and generating urea linkages in the resulting polymer structure. The carbon dioxide thus liberated results in foaming of the fiber-reacting mixture during the polymerization process, leading to the formation of a foamed composite. The isocyanate component can further comprise one or more catalysts for the control of the polymer forming reaction between the polyisocyanate and the isocyanate component. The isocyanate component may further comprise additional optional performance enhancing additives.

In one embodiment of the present invention, the isocyanate component comprises at least one organic polyol having a number averaged functionality of isocyanate reactive groups of at least 1.8. In practicing the process of the present invention, the number averaged functionality of the organic polyol is desirably from 1.8 to 10, more preferably from 1.9 to 8, still more preferably from 2 to 6, and most preferably from 2.3 to 4.

Polyols that furnish softblock segments are known to those skilled in the art as softblock polyols, or as flexible polyols. Softblock polyols generally have a number averaged molecular weight of at least about 1500, preferably from about 1750 to about 8000; a number averaged equivalent weight of from about 400 to about 4000, preferably from about 750 to 2500; and, a number averaged functionality of isocyanate reactive groups of about 1.8 to about 10, preferably from about 2 to about 4. Softblock polyols can include aliphatic polyether or aliphatic polyester polyols comprising primary and/or secondary hydroxyl groups. In practicing the process of the invention it is preferred that these softblock polyols comprise from about 0 to about 30% by weight and more preferably from about 0 to about 20% by weight of the isocyanate reactive species present in the polyol composition. Preferred softblock polyols are liquid at 25° C.

Polyols that provide structural rigidity are referred to in the art as rigid polyols. Rigid polyols generally have a number averaged molecular weight of about 200 to about 3000, preferably about 250 to less than 1500; a number averaged equivalent weight of about 80 to about 700, preferably about 85 to about 300; and, a number averaged functionality of isocyanate reactive groups of about 2 to about 10, preferably about 3 to about 6. Rigid polyols include, for example, polyether or polyester polyols comprising primary and/or secondary hydroxyl groups. Preferred rigid polyols are liquid at 25° C.

As noted above both the softblock polyols and the rigid polyols may be of either the polyether or the polyester type. Polyether based polyols are generally more preferred in the LFI process of the present invention. Suitable polyether polyols which can be employed in the reaction systems according to the preferred LFI process of the invention include those which are prepared by reacting an alkylene oxide, a halogen substituted or aromatic substituted alkylene oxide or mixtures thereof, with an active hydrogen containing initiator compound.

Suitable alkylene oxides include for example ethylene oxide, propylene oxide, 1,2-butylene oxide, styrene oxide, epichlorohydrin, epibromohydrin, mixtures thereof, and the like. Propylene oxide and ethylene oxide are particularly preferred alkylene oxides.

Suitable hydrogen containing initiator compounds include water, ethylene glycol, propylene glycol, butanediols, hexanediols, glycerine, trimethylolpropane, trimethylolethane, pentaerythritol, hexanetriols, sucrose, hydroquinone, resorcinol, catechol, bisphenols, novolac resins, phosphoric acid, and mixtures of these.

Further examples of suitable hydrogen containing initiator compounds include ammonia, ethylenediamine, diaminopropanes, diaminobutanes, diaminopentanes, diaminohexanes, diethylenetriamine, triethylenetetramine, tetraethylenepentamine, pentamethylenehexamine, ethanolamine, aminoethylethanolamine, aniline, 2,4-toluenediamine, 2,6-toluenediamine, 2,4′-diaminodiphenylmethane, 4,4′-diaminodiphenylmethane, 1,3-phenylenediamine, 1,4-phenylenediamine, naphthylene-1,5-diamine, triphenylmethane-4,4′,4″-tramine, 4,4′-di-(methylamino)-diphenylmethane, 1,3-diethyl-2,4-diaminobenzene, 2,4-diaminomesitylene, 1-methyl-3,5-diethyl-2,4-diaminobenzene, 1-methyl-3,5-diethyl-2,6-diaminobenzene, 1,3,5-triethyl-2,6-diaminobenzene, 3,5,3′,5′-tetraethyl-4,4′-diamiodiphenylmethane, and amine aldehyde condensation products such as the crude polyphenylpolymethylene polyamine mixtures produced from aniline and formaldehyde, and mixtures thereof.

Suitable polyester polyols include, for example, those prepared by reacting a polycarboxylic acid or anhydride with a polyhydric alcohol. The polycarboxylic acids may be aliphatic, cycloaliphatic, araliphatic, aromatic, and/or heterocyclic and may be substituted (e.g. with halogen atoms) and/or unsaturated. Examples of suitable carboxylic acids and anhydrides include succinic acid; adipic acid; suberic acid; azelaicNN acid; sebacic acid; pthtalic acid; isophthalic acid; terephthalic acid; trimellitic acid; phthalic anhydride; tetrahydrophthalic anhydride; hexahydrophthalic anhydride; tetrachlorophthalic anhydride; endomethylene tetrahydrophthalic anhydride; glutaric acid anhydride; maleic acid; maleic anhydride; fumaric acid; dimeric and trimeric fatty acids, such as those obtained from oleic acid, which may be in admixture with monomeric fatty acids. Simple esters of polycarboxylic acids may also be used in preparing polyester polyols. For example, terephthalic acid dimethyl ester, terephthalic acid bis glycol esters, and mixtures of these may be used.

Examples of polyhydric alcohols suitable for use in preparing polyester polyols include ethylene glycol; 1,3-, 1,4-, 1,2-, and 2,3-butanediols; 1,6-hexanediol; 1,8-octanediol; neopentyl glycol; cyclohexane dimethanol (1,4-bis-hydroxymethyl cyclohexane); 2-methyl-1,3-propanediol; glycerol; mannitiol; sorbitol; methylglucoside; diethylene glycol; trimethylolpropane; 1,2,6-hexanetriol; 1,2,4-butanetriol; trimethylolethane; pentaerythritol; triethylene glycol; tetraethylene glycol; polyethylene glycols; dipropylene glycol; tripropylene glycol; polypropylene glycols; dibutylene glycol; polybutylene glycols or any mixtures of these. The polyester polyols may optionally contain some terminal carboxy groups although preferably they are fully hydroxyl terminated. It is also possible to use polyesters derived from lactones such as caprolactone; or from hydroxy carboxylic acids such as hydroxy caproic acid or hydroxyacetic acid.

Polyols which are referred to the in the art as chain extenders and/or crosslinkers are another preferred class for use in LFI process of the present invention. These polyols have molecular weights from about 60 to less than about 200, preferably from about 60 to about 100; number averaged equivalent weights from about 30 to less than about 100, preferably about 30 to about 70; and, a number averaged functionality of isocyanate reactive groups of about 2 to about 4, preferably about 2 to about 3.

Examples of suitable chain-extenders/crosslinkers are simple glycols and triols such as ethylene glycol, propylene glycol, dipropylene glycol, 1,4-butanediol, 1,3-butanediol, triethanolamine, triisopropanolamine, tripropylene glycol, diethylene glycol, triethylene glycol, glycerol, mixtures of these, and the like. The most preferred chain-extenders/crosslinkers are liquids at 25° C. Although aliphatic —OH functional compounds, such as those just listed, are the more preferred chain-extenders/crosslinkers, it is within the scope of the invention to employ certain polyamines, polyamine derivatives, and/or polyphenols. Examples of suitable amines known in the art include diisopropanolamine, diethanolamine, and 3,5-diethyl-2,4-diaminotoluene, 3,5-diethyl-2,6-diaminotoluene, or any mixtures of these. Examples of suitable isocyanate reactive amine derivatives include certain imino-functional compounds such as those described in European Patent Application Nos. 284,253 and 359,456; and certain enamino-functional compounds such as those described in European Patent Application No. 359,456 having 2 isocyanate-reactive groups per molecule. Reactive amines, especially aliphatic primary amines, are less preferred due to their extremely high reactivity with polyisocyanates, but may optionally be used in minor amounts if desired.

It is to be understood that the terms “chain extender” and “crosslinker” are interchangeable in the context of the invention, as is often the case in the art. However the term “chain extender” is sometimes used in the art to refer only to difunctional low molecular weight isocyanate reactive species, whereas the term crosslinker is sometimes limited to low molecular weight isocyanates reactive species having a functionality of 3 or more.

In one embodiment of the present invention, the organic polyol composition comprises a mixture of (a) about 0 to 20% by weight of at least one polyol having a molecular weight of 1500 or greater and a functionality of about 2 to about 4; (b) about 70-98% weight of at least one polyol having a molecular weight between 200 and 500 and a functionality of about 2 to about 6; and (c) about 2 to about 15% by weight of a least one polyol having a functionality of about 2 to about 4 and a molecular weight of less than 200. All the polyol species in this preferred mixed polyol composition contain essentially all primary and/or secondary aliphatically bound organic —OH groups.

Another example of a polyol-based isocyanate component suitable for use in the preferred LFI process according to the present invention is a propylene oxide adduct of glycerol having a nominal functionality of 3 and a number-averaged hydroxyl equivalent weight of 86. (The term “nominal functionality” applied to polyols, as used in the context of this invention, denotes the expected functionality of the polyol based upon the raw materials used in its synthesis. The nominal functionality may differ slightly from actual functionality, but the difference may usually be ignored in the context of this invention.) This predominantly secondary-OH functional triol is an example of a rigid polyol, as per the description provided hereinabove. It is commercially available from Huntsman Polyurethanes as JEFFOL® G 30-650 polyol. Blends of this preferred polyol with glycerol is also an example of a preferred polyol composition for use in the LFI process of the present invention. In this preferred embodiment, the weight ratio of the JEFFOL® G 30-650 polyol to glycerol is in the range of from about 99:1 to about 50:50, preferably about 98:2 to about 90:10, and most preferably about 95:5 to about 90:10. This preferred polyol blend preferably comprises about 70% to 95% and more preferably about 80% to about 100% by weight of the isocyanate component. These polyol blends are particularly suitable for making expanded composite moldings according to preferred embodiments of the improved LFI process.

The nominal functionality of a polyoxyalkylene polyether polyol is the functionality of the initiator. This is particularly true for polyether polyols that are based predominantly on EO and/or PO (such as the JEFFOL® G 30-650 polyol, described above). The nominal functionality of a pure compound is, of course, the same as its absolute functionality. If a mixed initiator is used, then the nominal functionality of the polyol is the number averaged functionality of the mixed initiator.

In another embodiment, water, along with any other supplemental chemical blowing agent, is mixed with the organic polyol composition in the isocyanate component. The chemical blowing agent should be used in amounts totaling up to about 20% by weight, preferably about 0.1% to about 15% by weight, more preferably about 0.25% to about 10% by weight, and most preferably 0.4% to 5% by weight relative to the total weight of the isocyanate component. It is highly preferred that water is the principal chemical blowing agent and is used at a level of between 0.3% and 3.5% by weight of the total weight of the isocyanate component, preferably at a level of between 0.35% and 2.5% by weight relative to the total weight of the isocyanate component. Ideally, water is the sole blowing agent and is thus responsible for all of the foaming.

Other chemical blowing agents may also be used, in addition to or instead of water, in other embodiments of the improved LFI process. Examples of chemical blowing agents suitable for the process of the invention include known physical blowing agents such as volatile hydrocarbons, for example, aliphatic hydrocarbons of 3 to 5 carbon atoms; inert volatile fluorochemical blowing agents known in the art; injected or dispersed or dissolved atmospheric gases such as air, nitrogen, or carbon dioxide; and alternative chemical blowing agents such as azodicarbonamide, free carboxylic acids, hydroxyacetone, 4-hydroxy-2-butanone, or any combination of these. Chemical blowing agents other than water, when used, are preferably incorporated into one or more of the polymer precursor streams, and most preferably are incorporated into the isocyanate component stream.

In another embodiment, the isocyanate component contains one or more catalysts for promoting and controlling the appropriate polymer forming reaction. The catalysts are preferably admixed with the other ingredients comprising the isocyanate component.

The catalyst package may consist of a single catalyst or a mixture of two or more catalysts. Preferred catalysts include tertiary amines, tertiary amine acid salts, organic metal salts, and any combination of these. Examples of preferred tertiary amine catalysts include triethylenediamine, N,N-dimethyl cyclohexylamine, bis-(dimethylamino)-diethyl ether, N-ethyl morpholine, N,N,N′,N′,N″-pentamethyl diethylenetriamine, N,N-dimethyl aminopropylamine, N-benzyl dimethylamine, and aliphatic tertiary amine-containing amides of carboxylic acids, such as the amides of N,N-dimethyl aminopropylamine with stearic acid, oleic acid, hydroxystearic acid, and dihydroxylstearic acid. N,N-dimethylcyclohexylamine is a preferred tertiary amine catalyst. Examples of commercially available tertiary amine catalysts include the JEFFCAT® series of amines from Huntsman Petrochemical Corporation; the POLYCATO® series of amines and the DABCO® amine catalysts both available form Air Products and Chemicals Inc.

Examples of suitable tertiary amine acid salt catalysts include those prepared by partial neutralization of formic acid, acetic acid, 2-ethyl hexanoic acid, oleic acid, or oligomerized oleic acid with a tertiary amine such as triethylenediamine, triethanolamine, triisopropanolamine, N-methyl diethanolamine, N,N-dimethyl ethanolamine, mixtures of these amines, or the like. These amine salt catalysts are sometimes referred to as “blocked amine catalysts”, owing to delayed onset of catalytic activity so as to provide improved ease of mold filling.

Examples of preferred organic metal salts for use as catalysts include potassium 2-ethyl hexanoate, potassium oleate, potassium acetate, potassium hydroxide, dibutyltin dilaurate, dibutyltin diacetate, and dibutyltin dioleate.

Further examples of useful catalysts suitable for use in the invention include amido amine compounds derived from the amidization reaction of N,N-dimethyl propanedimine with fatty carboxylic acids. A specific example of such a catalyst is BUSPERSE® 47 catalyst from Buckman Laboratories.

Mixtures of tertiary amine, amine acid salt, and/or organic metal salt catalysts may be used. The use of mixed catalysts is well known to those skilled in the art of formulating isocyanate-based mixing activated reactive systems suitable for making composites using the LFI process. The total loading of catalysts, as a percent by weight of the total weight of the isocyanate component, will typically range from about 0.001% to about 7%. This loading range is more typically from about 0.1% to about 3% however.

The isocyanate component suitable for use in the improved LFI process according to the present invention may further comprise conventionally used additives such as flame retardants, particulate fillers, internal mold release agents, pigments, foam stabilizers, or other types of surfactants or conventional additives known in the art.

Useful flame retardants include phosphonates, phosphites, and phosphates, such as tris-(2-chloroisopropyl) phosphate (TCPP), dimethyl methyl phosphonate, ammonium polyphosphate, and various cyclic phosphates and phosphonate esters known in the art. Other useful flame retardants include halogen-containing compounds known in the art such as brominated diphenyl ether and other brominated aromatic compounds; melamine and compounds of melamine; antimony oxides such as antimony pentoxide and antimony trioxide; zinc compounds such as zinc oxide; alumina trihydrate; and magnesium compounds such as magnesium hydroxide. The flame retardants may be used in any suitable amount that will be evident to those skilled in the art. However, it is preferred that the flame retardants be used in an amount of 0 to about 55%, preferably 0 to 25%, by weight of the isocyanate component. The types of flame retardants most preferred in this application are liquid and soluble flame retardants, as opposed to solid fillers.

Other conventional optional additives which are known in the art and may be used in the reaction systems suitable for the process of the invention include particulate fillers such as calcium carbonate, silica, mica, wollastonite, wood flour, melamine, short glass or mineral fibers (short enough to be incorporated into the liquid reaction streams as fillers), glass or plastic microshperes, pigments, surfactants, and plasticizers. Such optional additives will be used in amounts that will be evident to one skilled in the art.

The isocyanate component suitable for use in the improved LFI process of the present invention may also contain internal mold release agents. A particularly preferred class of internal mold release agents are described in U.S. Pat. No. 5,576,409 which is incorporated herein fully by reference. An especially preferred internal mold release (IMR) system suitable for use in the LFI process of the invention comprises a combination of a fatty carboxylic acid and a fatty polyester. The IMR ingredients are preferably incorporated into the isocyanate component stream, according to the teachings of U.S. Pat. No. 5,576,409.

The use of an internal mold release package, or IMR, in the LFI process according to the present invention greatly improves the productivity in molding operations which use an LFI process, by reducing or eliminating the need to clean and re-treat the mold between molding cycles. The IMR package is preferably used in combination with an external mold release (XMR) applied to the surface of the mold itself. The XMR is usually applied to the clean mold surface at the beginning of a multi-part molding cycle. Examples of suitable XMR treatments known in the art include soaps and waxes, of the type used in the reaction injection molding (RIM) art.

Other IMR agents which may also be used in the process according to the present invention include silicones, known in the art to be effective as IMR agents in reactive polyurethane formulations; and, metal salts of fatty acids, such as zinc stearate, zinc oleate, calcium palmitate, zinc laurate, or any combination of these.

Examples of pigments that can be used in the LFI process of the present invention include carbon black, which is often dispersed in the isocyanate component. Carbon black may be introduced as a concentrated dispersion in a polyol. It is within the scope of the improved LFI process, although optional, to employ surfactants, such as foam stabilzing surfactants, in the isocyanate component stream. These optional surfactants may comprise polysiloxane based surfactants, including copolymers. The optional surfactants may also optionally comprise non-siloxane containing surfactants. The optional surfactants may be anionic, cationic, nonionic, zwitterionic, or combinations thereof.

### Reinforcing Fibers Stream

In addition to polymer precursor streams, the process of the present invention employs a reinforcing fibers stream. Suitable reinforcing fibers used in the present invention include structural fibers such as glass, carbon, metal, graphite, silicon carbide, alumina, titania, boron, cellulosic, lignocelluosic, aromatic polyamide, polyester, polyolefin, Nylon, or any mixture thereof. Glass fibers are particularly preferred. The final reinforced and shaped LFI composite article may contain between 0.5% to about 70% by weight and preferably from about 10% to about 60% by weight of reinforcing fiber material. A typical automobile door panel, produced by the LFI type process using the preferred process of the invention normally will contain from about 15% to about 35% glass fibers by weight (of the total weight of the glass-reinforced composite).

The diameter of the reinforcing fibers is not critical, and may for example, vary from about 0.001 mm to about 1.0 mm, but is more preferably in the range of about 0.01 mm to about 0.25 mm. The reinforcing fibers may optionally be pretreated with sizing agents, coatings, adhesion promoters, and other kinds of surface treatments known in the art of making isocyanate-based fiber reinforced composites.

### EXAMPLE 1

The following example shows the benefits of using the apparatus according to the present invention when compared to an apparatus of the prior art. The apparatus used in Example 1 had eight air injection ports evenly spaced in a ring surrounding the outlet port of the mixing head (“New Ring”), such that the gas flow from each port impinged directly upon the fiber-reacting mixture as it emerged from the mixing head. The design of the “New Ring” is according to the FIGS. 1-3. The other apparatus used in Example 1 was essentially the same, the difference being that it contained only four gas injection ports (“Old Ring”):

| | Old Ring: | New Ring: |
|---|---|---|
| Flex Modulus (25 C.): | 1.734 | 1.882 |
| | Mpa | Mpa. |
| Wt. % Glass (% Ash): | 54.0 | 50.6 |
| SPG: | 1.619 | 1.657 |
| Calculated Void Vol. % | 5.3 | 0.6 |
| Number of Samples: | 120 | 90 |

The properties shown above are the average for the indicated number of samples made in each of the two runs. The property differences are experimentally significant and very consistent.

The parts that were made using the New Ring (the apparatus according to the present invention) show a distinctly higher flex modulus, even at a lower glass fiber reinforcement content, as well as a higher density (lower void content by volume).

The chemical formulation used to prepare the LFI parts in Example 1 was a two-polymer precursor system consisting of the following two polymer precursor streams:

Polyisocyanate: RUBINATE® 8700 Isocyanate.

This isocyanate product is a liquid polymeric MDI having a number averaged functionality of about 2.7 and a free isocyanate group content of about 31.5% by weight. It is available commercially from Huntsman Polyurethanes.

Isocyanate Component: (Composition of Blended Ingredients by Weight, as Shown Below):

1) JEFFOL® G30-650 polyol: 100.0 pbw.

An aliphatic polyether nominal triol having an hydroxyl equivalent weight of about 86, commercially available from Huntsman Polyurethanes.

2) Glycerine: 7.5 pbw.

3) DABCO® 8800 catalyst: 0.33 pbw.

A proprietary tertiary aliphatic amine based catalyst, commercially available from Air Products and Chemicals Corporation.

4) POLYCAT® 8 catalyst: 1.0 pbw.

A tertiary aliphatic amine based catalyst, commercially available from Air Products and Chemicals Corporation. It is believed to consist essentially of N,N-dimethyl cyclohexylamine.

5) REACTINT® BLACK X-77 polymeric colorant: 2.5 pbw.

A proprietary polymeric black dye, commercially available from the Milliken Corporation.

The components making up this liquid mixing activated reaction system were processed at a weight ratio of 1.77 (A/B). This ratio corresponds to an isocyanate Index of 105%.

The reactive LFI formulation was processed using a Cannon A-40 metering unit. A Fanuc S-420i F robot and a Fanuc R-J2 robot control panel were used to pour the reaction mixture. The basic mixing head used in all of these Examples was a Cannon FPL24.

Fiberglass (Owens Corning 900A X3 4800 N Advantex), fed to the mixing head in continuous strands, was chopped during the shot to an average length of 2 inches.

The shot throughput for each part was 110 g/s for the polymer precursor system and 86 g/s glass fibers. This corresponds to a glass loading of 44% by weight. The shot duration, for each part, was set at 20 seconds.

The parts made according to the present invention were flat plaques and were produced by an open pour molding process. The mold was closed immediately after completion of the pour. Part thickness was 3.5 mm. The plaques were 24 inches wide and 42 inches long.

The mold used was a two platen mold, set in a 150 ton press. Parts were demolded four minutes after the mold was closed. Parts were then post-cured in an oven for 1 hour at 250° F., and allowed to cool to room temperature before testing.

Prior to adding to the mixing chamber, each polymer precursor was loaded into the appropriate tank on the metering unit under an atmosphere of dry air, and agitated for at least 30 minutes in order to reach the desired temperature (90° F. for both precursors). In addition, the isocyanate component was mixed for 15 minutes prior to loading in the isocyanate component tank.

The mold surfaces were pretreated with PURA B 12018 (wax) external mold release. This external mold release product is commercially available from ChemTrend (Howell, Mich.). The mold surfaces were re-treated after every individual part molding. The mold release was applied by spraying.

Additional processing conditions were as follows:

Component pressures (during shot): 1750 PSI for isocyanate component; and 1350 PSI for polyisocyanate

Mixing head orifice 0.6 mm adjustable (for isocyanate component), and 0.8 mm adjustable (for polyisocyanate) [both backed all the way out].

Mold temperature settings were 200° F. (top platen), and 180° F. (bottom platen).

Venturi air on mixing head was set at 3.0 bar.

Plus-air on mixing head was set at 30 PSI.

Robot program name “KAYLI_{—}8”.

Robot speed 265 mm/s.

Testing procedures and conditions used in measuring the manufactured reinforced fiber composite physical properties (quoted above) were as follows:

Flex Modulus: ASTM D-790, tested at 70° F., units of PSI.

Specific Gravity (SPG): ASTM D-792.

% Ash (A): ASTM D 1278-91A (1997), according to the formula:

A=100[(C−B)/D], where

A=% ash by weight, B=mass of empty crucible, D=mass of test specimen, and C=mass of crucible plus test specimen.

Although the above apparatus and process are described in terms of the above embodiments, those skilled in the art will recognize that changes in the apparatus and process may be made without departing from the spirit of the invention. Such changes are intended to fall within the scope of the following claims.

What is claimed:

1. A mixing apparatus for producing a fiber reinforced composite article comprising:
(a) a mixing chamber;
(b) metering means for adding at least two liquid polymer precursor streams to the mixing chamber;
(c) feeding means for delivering reinforcing fibers to the mixing chamber;
(d) mixing means wherein the polymer precursor streams and the reinforcing fibers are mixed and react to form a fiber reacting mixture;
(e) outlet means extending from the mixing chamber for directing the fiber reacting mixture onto a substrate; and
(f) at least five gas jets arranged peripherally around a ring adjacent to the outlet means wherein the gas jets are capable of delivering a stream of at least one gas into the fiber-reacting mixture as the fiber-reacting mixture emerges from the mixing means.

2. The mixing apparatus of claim 1 wherein the mixing chamber has two polymer inlet ducts and one fiber inlet duct.

3. The mixing apparatus of claim 2 wherein the outlet means consists of one outlet duct for dispersing the fiber reacting mixture from the mixing means.

4. The mixing apparatus of claim 1 wherein the metering means includes a pump.

5. The mixing apparatus of claim 1 wherein the feeding means includes rollers or a conveyor.

6. The mixing apparatus of claim 1 wherein the mixing means comprises a mixing head.

7. The mixing apparatus of claim 1 wherein the substrate is a mold.

8. The mixing apparatus of claim 1 wherein the gas jets having a same size are equally spaced around the ring and are connected to the same gas source for delivering the gas to the gas jets.

9. The mixing apparatus of claim 8 wherein the gas source delivers the gas to the gas jets by a single gas valve.

10. The mixing apparatus of claim 9 wherein the gas comprises an inert gas.

11. The mixing apparatus of claim 10 wherein the inert gas includes at least one of air, dry air, nitrogen, argon, helium or carbon dioxide.

12. The mixing apparatus of claim 1 wherein the gas jets are arranged in a circular plane whereby the outlet means of the mixing chamber is at a center point of the circular plane.

13. The mixing apparatus of claim 12 wherein each gas jet delivers an individual gas flow, the gas flow being set at an angle relative to the circular plane.

14. The mixing apparatus of claim 12 wherein each gas flow has an angle of about 45 degrees.

15. The mixing apparatus of claim 1 further comprising cutting means to break down the reinforcing fibers to a length of at least 0.25 inches prior to entering the mixing chamber.

16. A method for producing a shaped fiber reinforced composite article from at least a first and second polymer precursor stream and reinforcing fibers the method comprising:
(a) providing a mixing apparatus comprising:
(i) a mixing chamber,
(ii) metering means for adding the polymer precursor streams to the mixing chamber,
(iii) feeding means for delivering the reinforcing fibers to the mixing chamber,
(iv) mixing means wherein the polymer precursor streams and the reinforcing fibers are mixed and react to form a fiber reacting mixture,
(v) outlet means extending from the mixing chamber for directing the fiber-reacting mixture onto a substrate,
(vi) at least five gas jets arranged peripherally around a ring adjacent to the outlet means wherein the gas jets are capable of delivering a stream of at least one gas into the fiber-reacting mixture as the fiber-reacting mixture emerges from the mixing means;
(b) feeding the first and second polymer precursor streams and the reinforcing fibers into the mixing apparatus to produce a fiber reacting mixture;
(c) discharging the fiber-reacting mixture onto a substrate; and
(d) curing the fiber-reacting mixture in the substrate.

17. The method of claim 16 wherein the first polymer precursor stream is a polyisocyanate.

18. The method of claim 17 wherein the polyisocyanate is an organic polyisocyanate.

19. The method of claim 16 wherein the second polymer precursor stream is an isocyanate component comprising at least one organic polyol.

20. The method of claim 19 wherein the second polymer precursor stream further comprises a chemical blowing agent.
